(19) United States
(12) Patent Application Publication
(10) Pub. No.: US 2016/0059873 A1
(43) Pub. Date: Mar. 3, 2016

(54) LIGHT SIGNAL

(71) Applicant: SIEMENS AKTIENGESELLSCHAFT, München (DE)

(72) Inventor: Rudolf TEMMING, KOENIGSLUTTER (DE)

(21) Appl. No.: 14/780,619

(22) PCT Filed: Mar. 11, 2014
(86) PCT No.: PCT/EP2014/054659

§ 371 Date: Sep. 28, 2015

(30) Foreign Application Priority Data
Mar. 27, 2013 (DE) 10 2013 205 439.4

(51) Int. Cl. B61L 5/12; F21V 11/08; F21V 5/04

(52) U.S. Cl. CPC B61L 5/125; F21V 5/045; F21V 11/08; B61L 2207/00

(57) ABSTRACT

A light signal, more particularly for rail-bound traffic routes, includes a light source and an optical system for signal aspect visualization, more particularly into a far range and a near range angled relative thereto. In order to achieve a reduction of phantom light that suffices to be able to dispense with a shield, provision is made for the optical system to include a Fresnel lens, the light entrance surface of which has Fresnel structures and the light exit surface of which is constructed in such a way that every tangent to the light exit surface is at an angle of ≧105° relative to an optical axis of the optical system.

The invention relates to a light signal, in particular for rail-bound traffic routes, comprising a light source and an optical system for signal aspect visualization, in particular into a far range and a near range angled relative thereto.

In principle, light signals serve as signal generators or symbol indicators which transmit specific information by coloring and/or shaping an illuminated surface, i.e. by the radiation characteristic. This is frequently safety-relevant information which should never be optically distorted or superimposed by extraneous light. The undesirable illumination and/or distortion of a point of light by incident ambient light, for example solar radiation or headlamp light, is denoted as the phantom effect. In extreme cases the phantom effect may lead to a distorted display, as a result of an ill-timed illumination of a point of light or color shift. This effect is particularly disruptive when LED arrangements are used as the light source, as LEDs may be excited to light up by incident light and/or rearwardly facing reflectors are frequently used in LED light sources.

In addition to the known causes of the phantom effect which are able to be anticipated during the design and planning stage, for example low-lying sun for signals positioned in an east-west orientation, occasionally reflections on surfaces occur, for example on glazed facades or snow cover, or unforeseen sources of phantom light are also present, for example vehicle headlights or construction lamps. Thus, even a signal which should be phantom-proof due to the location, may be susceptible to a phantom effect.

The following description refers substantially to light signals for representing signal aspects in rail-bound traffic routes, without the claimed subject-matter being intended to be limited to this application.

In railway signals it has to be ensured that when the tractive vehicle driver approaches the designated signal, the driver is always able to identify the signal clearly. In this case, different track geometries, i.e. straight tracks, corners and/or differences in gradient have to be taken into account. In addition to a far range view of the signal, a near range view of the signal is also required so that the tractive vehicle driver is able to identify the light signal even when he is directly in front of the signal. In this case, significant reflections may occur, in particular on the light exit surfaces of the optical system, which may result in light phantoms and ultimately in dangerous signal aspects.

Reflections due to extraneous light, primarily sunlight, occur more intensively on the light entry surfaces and the light exit surfaces of a protective glass and the optical system, for example of a Fresnel lens, as well as on components in the region of the light source. In order to reduce the reflections on the surfaces of the protective glass, it is usual to arrange the protective glass at an oblique position of ca. 15° relative to the line of sight of the tractive vehicle driver.

Generally, attempts have been made to minimize the phantom effect by shields, diaphragms, avoiding an east-west orientation or by repeating critical signals.

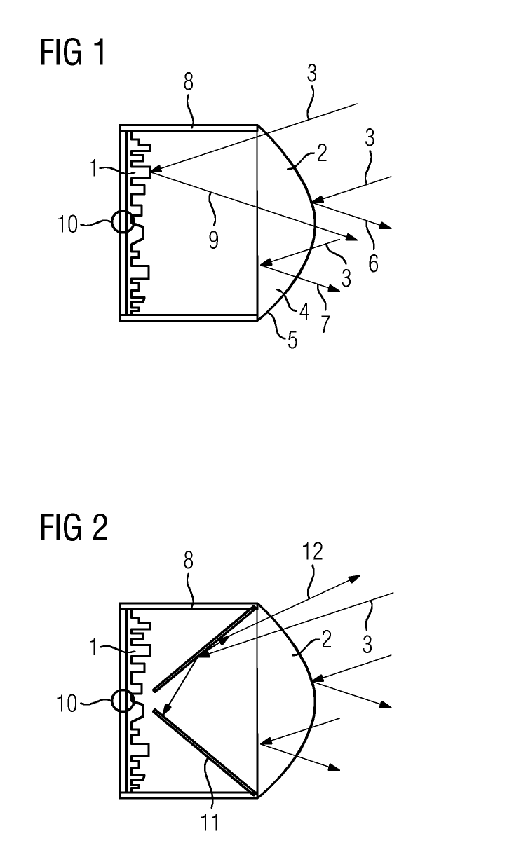

FIG. 1 shows the reflective conditions which are to be improved and which are caused by the internal components 1 and a lens 2 of a light signal. It may be seen that the sunlight 3 incident on the lens 2 obliquely from above is reflected on the outer and inner surfaces 4 and 5 thereof partially obliquely downward 6 and 7. Moreover, sunlight 3 passing through the lens 2 may be reflected obliquely downward 9 on the internal components 1 inside a signal housing 8 at a disadvantageous angle as disruptive phantom light. The reflected phantom light 6, 7 and 9 interferes with the information to be visualized by a light source 10. The housing 8 which encloses all of the components also serves to shield at least one portion of the sunlight 3, both on the inside and on the outside. Generally, a further portion of the sunlight 3 is shielded by a shield covering the lens 2 in the upper region, not shown here.

It is disclosed in DE 101 07 256 A1, DE 26 20 962 C2 and DE 10 2010 024 381 A1 that specific shields and diaphragms are used to counteract the phantom effect in order to adopt as many incidence paths and/or angles of incidence as possible for the incident phantom light. Frequently, diffuser disks or grey-colored protective glass which have a diffuser segment for near range illumination, or even light guide segments for deflecting a component light beam into the near range, are required for signal aspect visualization in the near range. As a result, however, a compromise is necessary, which leads to a high degree of light loss having to be taken into account due to the phantom protective effect, so that a light source with correspondingly high luminosity is required. As a result, the heat generation is increased and finally the service life of the light source is reduced. In particular, with multicolored light signals the luminosity is potentially no longer sufficient. This in turn increases the costs as for different requirements, in particular relative to luminosity, different variants have to be implemented for the optical system and potentially also for the appropriate light source.

Particularly noticeable light losses occur by the widespread use of roof-like shields and special protective glass. Shields also have the drawback that a high wind load is produced which has to be compensated by a correspondingly stable signal mast construction. Further signals may be concealed due to snow on the shield. Moreover, as the shield frequently protrudes quite considerably over the light exit surface of the signal, the use of self-cleaning coatings on the light exit surface, which require solar radiation and rainfall, is hampered.

The object of the invention is to provide a light signal of the generic type in which it is possible to avoid substantially a reduction in safety and significant light losses due to the phantom effect, wherein it is desirable that shields and/or protective glass are unnecessary.

According to the invention, the object is achieved in that the optical system comprises a Fresnel lens, the light entry surface thereof having Fresnel structures and the light exit surface thereof being designed in such a way that every tangent to the light exit surface is at an angle of ≧105° relative to an optical axis of the optical system.

In this manner, it is achieved that almost all of the light reflected as a result of the phantom effect on the Fresnel lens on the light entry side and the light exit side is deflected into regions outside the line of sight of the tractive vehicle driver. As the Fresnel structures are provided on the light entry surface and thus on the inner surface and not, as is usual, on the outer surface of the Fresnel lens, the light exit surface may be configured to be smooth and virtually without undulations. Due to this outer surface which is smooth and thus less susceptible to soiling, a protective glass is no longer required. Moreover, the shaping of the Fresnel lens according to the invention is sufficiently phantom-proof in order to be able to dispense with a shield as additional phantom protection. This results in cost advantages. Moreover, the wind load is reduced so that even the signal mast may be produced more cost-effectively. Reduced visibility of other signals, for example due to snow or birds nests on the shield, no longer occurs. Moreover, by a special coating of the smooth outer surface of the Fresnel lens, a self-cleaning function is possible even without a shield. The rainfall required therefor, combined with solar radiation of the outer surface of the lens system, is no longer hampered by a shield.

As claimed in claim 2, it is provided that a funnel-shaped diaphragm is arranged between the light source and the optical system. This additional measure improves the phantom protection if the internal components adjacent to or in the vicinity of the light source may produce light phantoms. In this case, the narrow opening of the funnel-shaped diaphragm is adapted to the light exit surface of the light source, whilst the wide opening of the funnel-shaped diaphragm corresponds to the aperture of the optical system.

The invention is described in more detail hereinafter with reference to the drawings, in which:

FIG. 1 shows a simplified view of disruptive phantom light reflections,

FIG. 2 shows the phantom light reduction in the signal interior,

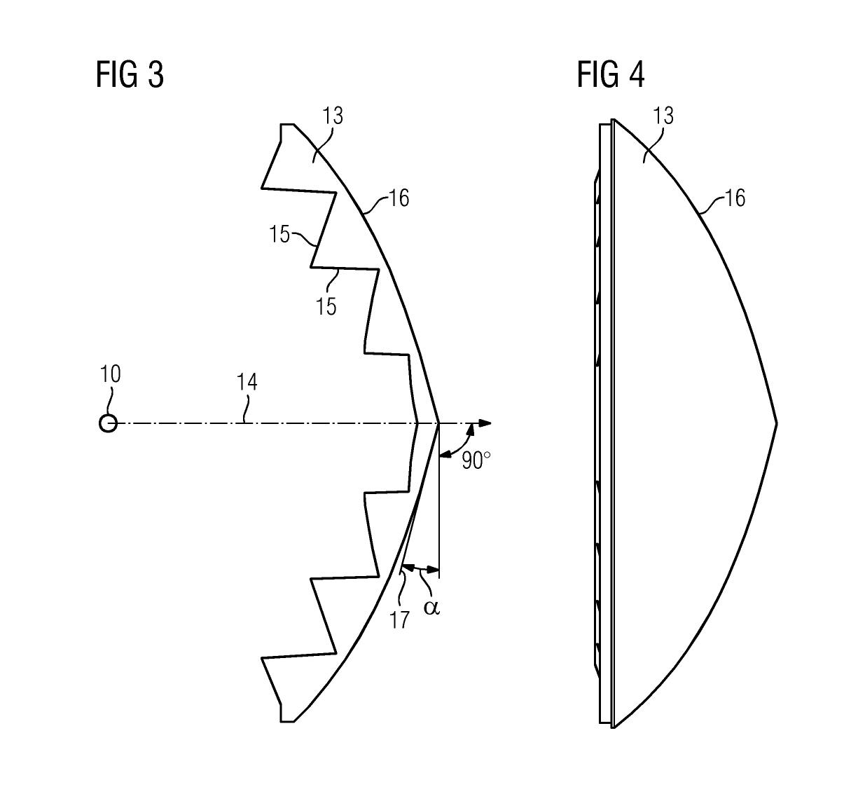

FIG. 3 shows the phantom light reduction by shaping a Fresnel lens according to the invention,

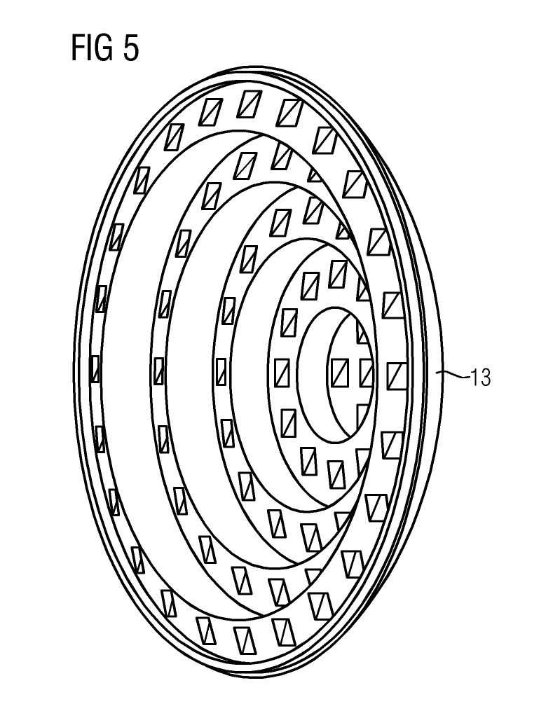

FIG. 4 shows the Fresnel lens according to FIG. 3 in side view and

FIG. 5 shows the Fresnel lens according to FIG. 3 in perspective view.

The problem with phantom-producing sunlight 3 has already been set forth above with reference to FIG. 1.

The light refraction inside the lens 2 has not been considered in FIGS. 1 and 2 for the purpose of simplification.

FIG. 2 illustrates the possibility of reducing the phantom light 9 caused by the internal components 1. To this end, a funnel-shaped diaphragm 11 is provided. The funnel-shaped diaphragm 11 encompasses the light source 10 with its narrow opening and is widened as far as the edge region of the inner surface 5 of the lens 2. As a result, the internal components 1 are no longer able to generate phantom light 9. The sunlight 3 is incident on the internal surface of the funnel-shaped diaphragm 11, is partially absorbed there and repeatedly reflected so that only outwardly reflected light 12 of exceptionally low luminosity is able to be produced, which only partially interferes as phantom light, whilst the largest proportion is radiated in an irrelevant solid angle.

FIG. 3 shows a further possibility for effectively reducing the phantom effect. The cross section of a thin disk of a Fresnel lens 13 in the region of an optical axis 14 is shown. The Fresnel lens 13 is shaped with Fresnel structures 15 on the light entry surface and with a smooth light exit surface 16. In this case, for all points of the light exit surface 16 an angle of 90°+α is provided between the tangent 17 at this point and the optical axis 14, wherein α is ≧15°. This results in a considerable reduction in phantom light as the majority of the light 6 and 7 which is reflected inwardly and outwardly on the lens 2 is no longer radiated in the line of sight of the tractive vehicle driver but in irrelevant solid angles.

FIG. 4 shows a side view and FIG. 5 shows a perspective view of the Fresnel lens 13. Due to the quite considerable reduction in phantom light of this specific shaping of the Fresnel lens 13, in particular with the simultaneous use of the funnel-shaped diaphragm 11, it is possible to dispense with the usual shield covering of the Fresnel lens 13. Also, a protective glass is not required due to the smooth outer surface 16 of the Fresnel lens 13. The outer surface 16 is able to be designed to be virtually self-cleaning by the special coating, as the exposure to rain of the outer surface which is required for the cleaning action is no longer hampered by a shield.

1-2. (canceled)

3. A light signal, comprising:
a light source; and
an optical system for signal aspect visualization, said optical system including an optical axis and a Fresnel lens, said Fresnel lens having a light entry surface with Fresnel structures and a light exit surface constructed in such a way that every tangent to said light exit surface is at an angle of ≧105° relative to said optical axis of said optical system.

4. The light signal according to claim 3, wherein the light signal is configured for rail-bound traffic routes.

5. The light signal according to claim 3, wherein said optical system is configured for signal aspect visualization into a far range and a near range angled relative to said far range.

6. The light signal according to claim 3, which further comprises a funnel-shaped diaphragm disposed between said light source and said optical system.
